(19) United States
(12) Patent Application Publication
(10) Pub. No.: US 2017/0140576 A1
(43) Pub. Date: May 18, 2017

(54) SYSTEMS AND METHODS FOR AUTOMATED PERSONNEL IDENTIFICATION

(71) Applicant: MOTOROLA SOLUTIONS, INC., Schaumburg, IL (US)

(72) Inventors: Bing Qin Lim, Jelutung (MY); Chee Kit Chan, Ipoh (MY); Boon Kheng Hooi, Alor Star (MY); Murali Kuyimbil, Bayan Baru (MY); Wai Mun Lee, Penang (MY); Wooi Ping Teoh, Georgetown (MY)

(21) Appl. No.: 14/939,324

(22) Filed: Nov. 12, 2015

(51) Int. Cl. G06T 19/00; H04B 10/116

(52) U.S. Cl. CPC G06T 19/006; H04B 10/116

(57) ABSTRACT

An automated personnel identification system. The system includes a portable communications device that stores an identifier, which uniquely identifies the portable communications device, a user of the portable communications device, or both. The system also includes a garment. The garment includes a communications interface, a light source, and an electronic controller electrically coupled to the communications interface and to the light source. The electronic controller is configured to receive the identifier, via the communications interface, from the portable communications device. The electronic controller is further configured to cause the light source to generate a modulated optical output based on the identifier. In some embodiments, the electronic controller is further configured to receive a status indication from the portable communications device via the communications interface, and activate the light source based on the status indication.

### BACKGROUND OF THE INVENTION

Some emergency incidents require responses from many public safety personnel, who may be from multiple agencies or departments. Identifying individual personnel during a response may be challenging. For example, personnel from the same department often wear nearly-identical uniforms, some personnel may be masked for safety, and personnel may be too far from each other for accurate visual identification. Even when using visual enhancement devices (for example, a head-mounted display or a remote console showing live video of the response), noise, and hectic pace and environment, smoke, or low-light conditions at an emergency scene may make it difficult for public safety personnel to identify each other. The analysis of recorded video of the public safety responses, during post-incident review suffers from similar limitations. Poor lighting conditions, partially obstructed images, and personnel too far from the camera may make manual identification of individual personnel difficult or impossible.

Accordingly, there is a need for an automated personnel identification system.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of an automated personnel identification system in accordance with some embodiments.

FIG. 2A, FIG. 2B, and FIG. 2C illustrate images processed by the automated personnel identification system of FIG. 1 in accordance with some embodiments.

FIG. 3 is a graphical user interface in accordance with some embodiments.

FIG. 4 is a graphical user interface in accordance with some embodiments.

FIG. 5 is a graphical user interface in accordance with some embodiments.

FIG. 6 is a flowchart of a method of operating an automated personnel identification system in accordance with some embodiments.

FIG. 7 is a flowchart of a method of operating an automated personnel identification system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides an automated personnel identification system. The system includes a portable communications device that stores an identifier, which uniquely identifies the portable communications device, a user of the portable communications device, or both. The system also includes a garment. The garment includes a communications interface, a light source, and an electronic controller electrically coupled to the communications interface and to the light source. The electronic controller is configured to receive the identifier, via the communications interface, from the portable communications device. The electronic controller is further configured to cause the light source to generate a modulated optical output based on the identifier. In some embodiments, the electronic controller is further configured to receive a status indication from the portable communications device via the communications interface, and activate the light source based on the status indication.

Another exemplary embodiment includes a method for operating a personnel identification system that includes a portable communications device and a garment. The method includes storing, by the portable communications device, an identifier associated with a user. The method further includes receiving, by an electronic controller of the garment, the identifier from the portable communications device. The method further includes causing, by the electronic controller, a light source of the garment to generate a modulated optical output based on the identifier.

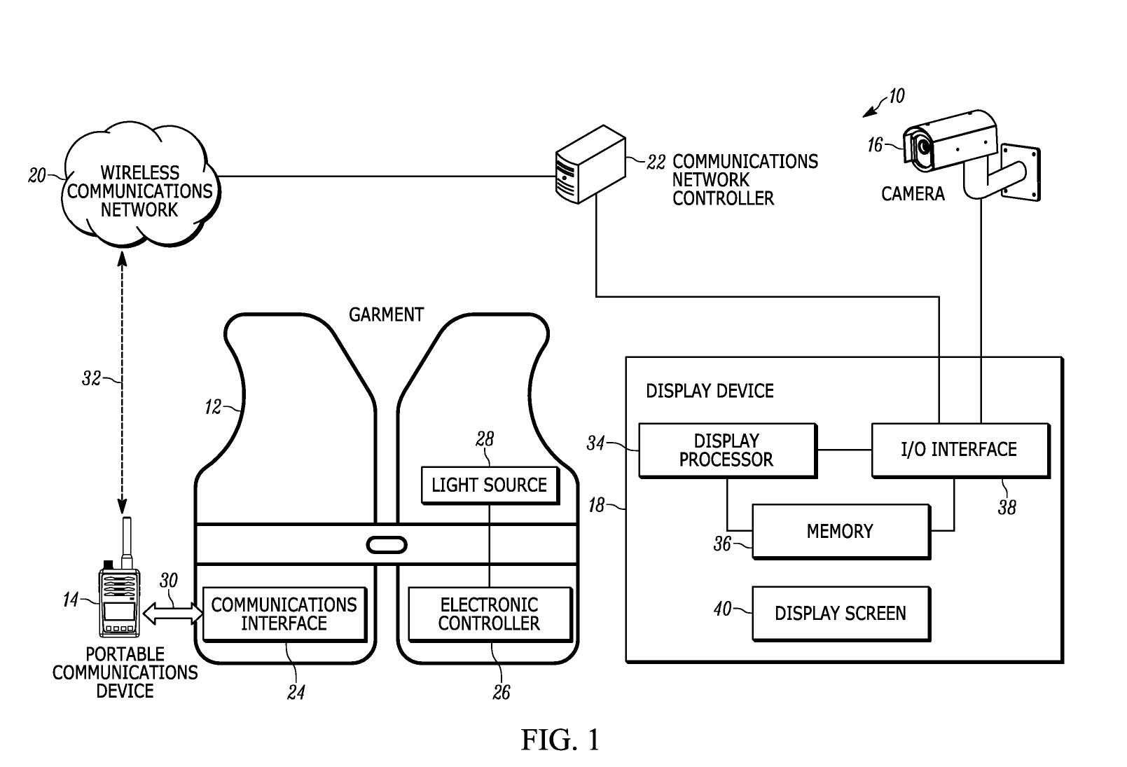

FIG. 1 is a block diagram of an automated personnel identification system 10, according to one embodiment. In the example illustrated, the automated personnel identification system 10 includes a garment 12, a portable communications device 14, a camera 16, a display device 18, a wireless communications network 20, and a network communications controller 22. For ease of description, the automated personnel identification system 10 illustrated in FIG. 1 includes a single garment 12, portable communications device 14, camera 16, display device 18, wireless communications network 20, and network communications controller 22. Alternative embodiments may include one or more of each component, or may exclude or combine some components.

The garment 12 includes a communications interface 24, an electronic controller 26, and a light source 28. The garment 12 also includes a suitable power source (for example, a battery (not shown)) for the communications interface 24, the electronic controller 26, and the light source 28. The power source may be internal or external to the garment 12. In alternative embodiments, the power source may power other components of the garment 12 (not shown), or components attached to the garment 12(not shown), either through a wired or wireless power connection. In some embodiments, the garment 12 is constructed from suitable weather-resistant materials that also provide protection dust and moisture for the electrical components of the garment 12. In certain embodiments described herein, the garment 12 has particular usefulness for public safety personnel (for example, police, firefighters, and emergency medical technicians). However, use of the garment 12 or the automated personnel identification system 10 is not limited to public safety applications.

In the illustrated example, the garment 12 is a vest. In alternative embodiments, the garment 12 may be a part of, or integrated into a part of, a shirt, jacket, pants, or even a hat or helmet. For example, the garment 12 may be some or all of a uniform shirt or jacket. In other embodiments, the garment 12 may be the outer (that is, visible) portion of a bullet-proof or other protective vest.

The communications interface 24, the electronic controller 26, and the light source 28 are electrically coupled to provide communication, power, and control. The communications interface 24 establishes a communications link 30 with the portable communications device 14 using a suitable wireless modality, for example, a short-range wireless network protocol (for example, a Bluetooth® standard protocol). In alternative embodiments, the communications interface 24 provides a wired connection to the portable communications device 14.

In one exemplary embodiment, the electronic controller 26 is a microcontroller that includes at least an electronic processor, memory, and input/output interface. The electronic processor executes computer readable instructions (“software”) stored in the memory to control the garment 12 as described herein. The electronic controller 26 receives data from the portable communications device 14 via the communications interface 24. As discussed in detail below, the electronic controller 26 controls the emissions of the light source 28 based on the data received from the portable communications device 14.

The light source 28 may include one or more light-emitting diodes (LEDs). The light source 28 contains elements capable of emitting light in at least the visible and infrared spectrums. By using one or more flexible light guides (not shown), such as, for example, a fluid contained in an exterior layer of the garment 12, the light source 28 illuminates substantially all of the garment 12 when activated. Accordingly, a device capable of sensing the emitted light (for example, in the case of the infrared spectrum, the camera 16, or, in the case of the visible spectrum, the camera 16 or the naked eye), will see the garment 12 itself as a single source of emitted light, rather than one or more discrete sources of light. In alternative embodiments, the light source 28 is made up of multiple individual light-emitting diodes (LEDs), covering substantially all of the garment 12. In some embodiments, the electronic controller 26 controls the light source 28 to modulate its emission of light (for example, activating and deactivating the light source 28 in a sequence) to convey data using a suitable protocol (for example, Infrared Data Association (IrDA) specifications). In alternative embodiments, the electronic controller 26 controls the light source 28 to emit a particular wavelength within the visible spectrum (that is, a color) to convey information according to a pre-determined mapping (for example, the color blue matches to a talk group associated with law enforcement).

The portable communications device 14 includes hardware and software that provide the capability for the portable communications device 14 to communicate with the wireless communications network 20, for example, over the wireless link 32. In the illustrated embodiment, the portable communications device 14 is a portable two-way radio, for example, one of the Motorola® ASTRO® family of radios. In alternative embodiments, the portable communications device 14 may be a cellular telephone, a smart telephone, or other electronic communications device that includes or is capable of being coupled to a network modem or components to enable wireless network communications (such as an amplifier, antenna, and the like). As illustrated, the portable communications device 14 is proximately located with the garment 12. In alternative embodiments, the portable communications device 14 may be integrated within the garment 12.

The portable communications device 14 also communicates via the communications link 30 to the communications interface 24 to send data to the electronic controller 26 of the garment 12. The data includes identifiers and status indications. An identifier may be used to uniquely identify the portable communications device 14, or a user of the portable communications device 14. Examples of identifiers include talk group identifiers, user identifiers (for example, name, rank, agency, assignment), or other information that identifies either the user of the portable communications device 14, or a characteristic of that user. In some embodiments, identifiers are stored in the memory 36 of the garment 12. In some embodiments, an identifier contains the information to be displayed (for example, “OFC. J. SMITH, POLICE”). In another example, the identifier includes a color code or a graphic to be overlaid on the display image (for example, a blue color vest to be overlaid on the image of a law enforcement officer with Talk Group A). In alternative embodiments, the identifier is a reference (for example, an employee identification number) used by the display device 18 to retrieve more extensive information from, for example, a local or external database (not shown). Examples of status indications include information that identifies the status of the portable communications device 14 itself (for example, whether it is transmitting or receiving).

In the illustrated embodiment, the wireless communications network 20 is a public safety land mobile radio (LMR) network and may be, for example, implemented in accordance with the Association of Public Safety Communications Officials (APCO) Project 25 (P25) two-way radio communications protocol. In alternative embodiments, the wireless communications network 20 may operate using other two-way radio communications protocols and standards. The wireless communications network 20 enables communication between the portable communications device 14 and other communications devices. The wireless communications network 20 is controlled by a communications network controller 22. The communications network controller 22 includes one or more computer systems suitable for controlling the operation of the wireless communications network 20. The communications network controller 22 may include an automated dispatch system that allows a user (for example, a public safety dispatcher) to interact with and control the wireless communications network 20.

The camera 16 is capable of capturing images, including a portion or all of the garment 12, by sensing light in at least the visible and infrared spectrums. The camera 16 is electrically coupled to the display device 18. The camera 16 communicates the captured images to the display device 18 over a suitable wired or wireless connection. It should be noted that the terms “image” and “images,” as used herein, may refer to one or more digital images captured by the camera 16, or processed or displayed by the display device 18. Further, the terms “image” and “images,” as used herein, may refer to still images or sequences of images (that is, video). As illustrated, the camera 16 is a stand-alone device. In alternative embodiments, the camera 16 may be integrated within the display device or another device, such other portable communications devices in the vicinity of the garment 12.

The display device 18 includes a display processor 34, a memory 36, an input/output interface 38, and a display screen 40, that , along with other various modules and components, are coupled to each other by or through one or more control or data buses, which enable communication therebetween. The memory 36 may include a program storage area (e.g., read only memory (ROM)) and a data storage area (e.g., random access memory (RAM)), and another non-transitory computer readable medium. The display processor 34 may be a microprocessor or similar electronic device, is coupled to the memory 36, and executes computer readable instructions (“software”) stored in the memory 36. For example, software for performing methods as described hereinafter may be stored in the memory 36. The software may include one or more applications, program data, filters, rules, one or more program modules, and/or other executable instructions.

The input/output interface 38 operates to receive user input, to provide system output, or a combination of both. User input may be provided via, for example, a keyboard/keypad, a microphone, softkeys, icons, or softbuttons on a touch screen (on, for example, the display screen 40), a scroll ball, a mouse, buttons, and the like. The input/output interface 38 may also include other input mechanisms, which for brevity are not described herein and which may be implemented in hardware, software, or a combination of both. In some embodiments, the input/output interface 38 includes a push-to-talk (PTT) button for remotely activating a two-way radio modem (not shown), which button may implemented, for example, as a physical switch or by using a soft key or icon on the display screen 40.

The display screen 40 is a suitable display such as, for example, a liquid crystal display (LCD) touch screen, or an organic light-emitting diode (OLED) touch screen. In alterative embodiments, the display screen 40 may not be a touch screen. The input/output interface 38 provides system output via, among other things, the display screen 40.

In exemplary embodiments described herein, the input/output interface 38 includes a graphical user interface (GUI) (for example, generated by the display processor 34, from instructions and data stored in the memory 36, and presented on the display screen 40) that enables a user to interact with the display device 18.

The display device 18 is electrically coupled, via a wired or wireless connection, to the communications network controller 22, and is configured to communicate with, and control aspects of, the wireless communications network 20. For example, the display device 18 may be used to control membership in talk groups of the wireless communications network 20 by sending appropriate commands to the communications network controller 22. In another example, a push-to-talk button generated by a graphical user interface of the display device 18 may be used to activate a two-way radio to transmit to the portable communications device 14 or other devices on the wireless communications network 20. In alternative embodiments, the display device 18 is configured to operate with an ad-hoc or peer-to-peer wireless communications network (that is, a network lacking a communications network controller 22). As illustrated, the display device 18 is a stand-alone device. In alternative embodiments, the display device 18 may be integrated within another device, such other portable communications devices, portable computers, and the like.

The camera 16 and the display device 18 may be implemented as a single device, or may be implemented separately. For example, in one embodiment, the display device 18 is integrated with the camera 16 in a head-mounted display (HMD) or an optical head-mounted display (OHMD). In another example, the display device 18 is a computer console located in a control center (for example, a public safety dispatch center) and the camera 16 is located remotely from the control center, and the display device 18 receives images captured by the camera 16 over one or more wired or wireless networks.

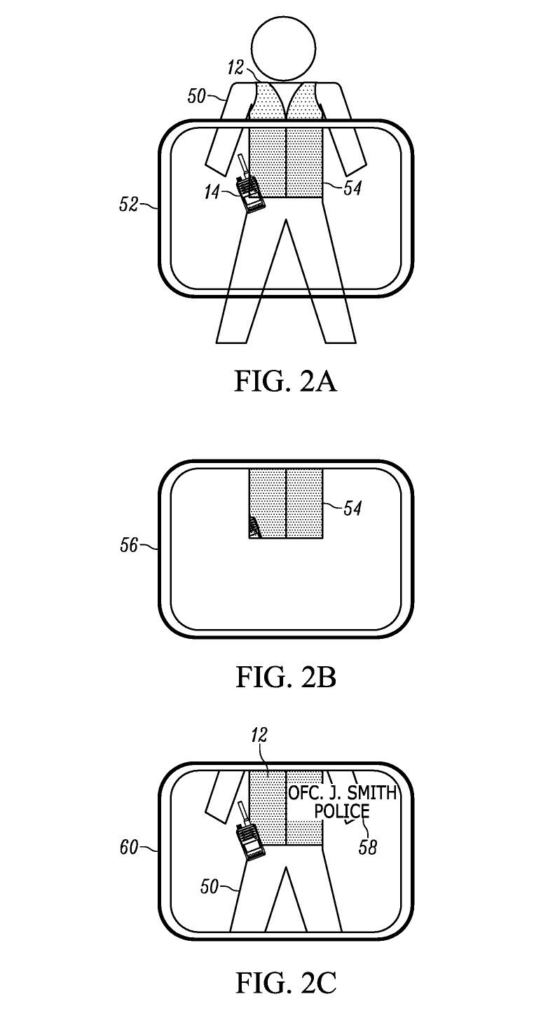

Whether integrated or distinct from each other, the display device 18 is capable of receiving and processing images captured by the camera 16, and displaying processed images in a graphical user interface on the display screen 40. Computerized image capturing and processing techniques are known, and will not be described in detail. The camera 16 captures images that contain both visible and infrared light. For example, FIG. 2A illustrates a police officer 50, wearing the garment 12 and the portable communications device 14. The first image 52, which includes an ordinary image of portions of the police officer 50 and the garment 12, and an infrared image 54 of the garment 12. The display device 18 is configured to process the first image 52 and extract information from it. For example, FIG. 2B illustrates a second image 56, which has been produced by the display device 18 by isolating the infrared image 54 from the first image 52. As noted above, the light source 28 modulates the emitted infrared light to encode and transmit data, such as identifiers or status indications received from the portable communications device 14.

The display device 18 is configured to detect the modulated optical outputs, extract the data encoded in them, and process images based on that data. For example, the data extracted may represent an identifier representing or associated with the wearer of the garment 12 or the user of the portable communications device 14. For example, in FIG. 2C the display device 18 has extracted a user identifier 58 from the infrared image 54. The display device 18 overlays the user identifier 58 “OFC. J. SMITH, POLICE” on the image of the police officer 50 from the first image 52 to produce a third image 60 (that is, an overlay image), which it can display on the display screen 40. Once an identifier has been extracted and overlaid onto an image (for example, of the garment 12 that was the source of the identifier), the identifier “sticks” to that image. For example, the user identifier 58 will move with the image of the police officer 50 as the police officer 50 moves through a video sequence.

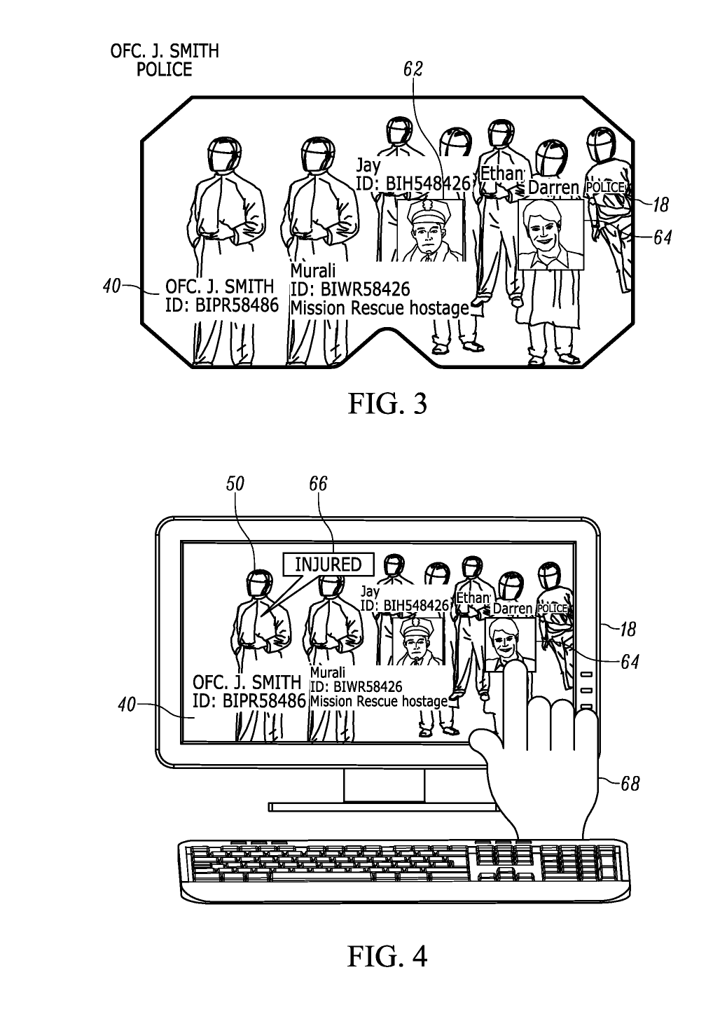

The display device 18 is capable of processing images that include multiple garments. The display device 18 is further capable of isolating a modulated infrared light emitted from each garment or portion of garment in the image, extracting an identifier from each modulation, and displaying the identifiers on a single overlay image. For example, FIG. 3 illustrates an exemplary embodiment of the display device 18 as a head-mounted display. The display device 18 is displaying on the display screen 40 a single overlay image that depicts five identifiers overlaid on five personnel in the image. The display device 18 is also capable of displaying identifiers including text, graphics, or both. For example, a commander 62 and a second police officer 64 are identified with graphics (for example, pictures of the commander 62 and the second police officer 64, respectively) as well as text. The graphics may be stored in the memory 36, or may be provided to the display device 18 by the communications network controller 22, or another system. The display device 18 is also capable of displaying information, in addition to the identifiers, regarding the identified personnel. In one example, as illustrated in FIG. 4, the display device 18 displays an information bubble 66 for the police officer 50 indicating that he is injured.

As illustrated in FIG. 4, the display screen 40 is capable of receiving commands related to the identifiers displayed. For example, a console operator 68 may select the second police officer 64 by touching the appropriate identifier on the display screen 40 (implemented in this example as a touch screen). In alternative embodiments, other input means may be used to select an identifier. For example, where the display device 18 is a head-mounted display, a sensed eye movement, a voice command, or both may be used to select an identifier. In some embodiments, more conventional input means, such as a keyboard and/or a pointing device, may be used to select one or more identifiers. Commands may include, for example, an information request (for example, a request to add information about an injury to an identifier) and a push-to-talk request (for example, establishing communications with the communications device associated with the identifier, or with the talk group listed in the identifier). Commands may also include a talk group configuration request (for example, a request to modify the configuration of the portable communications device 14 by removing it from, or assigning it to, a talk group) and a channel configuration request (for example, a request to modify the configuration of the portable communications device 14 by adding or removing channels).

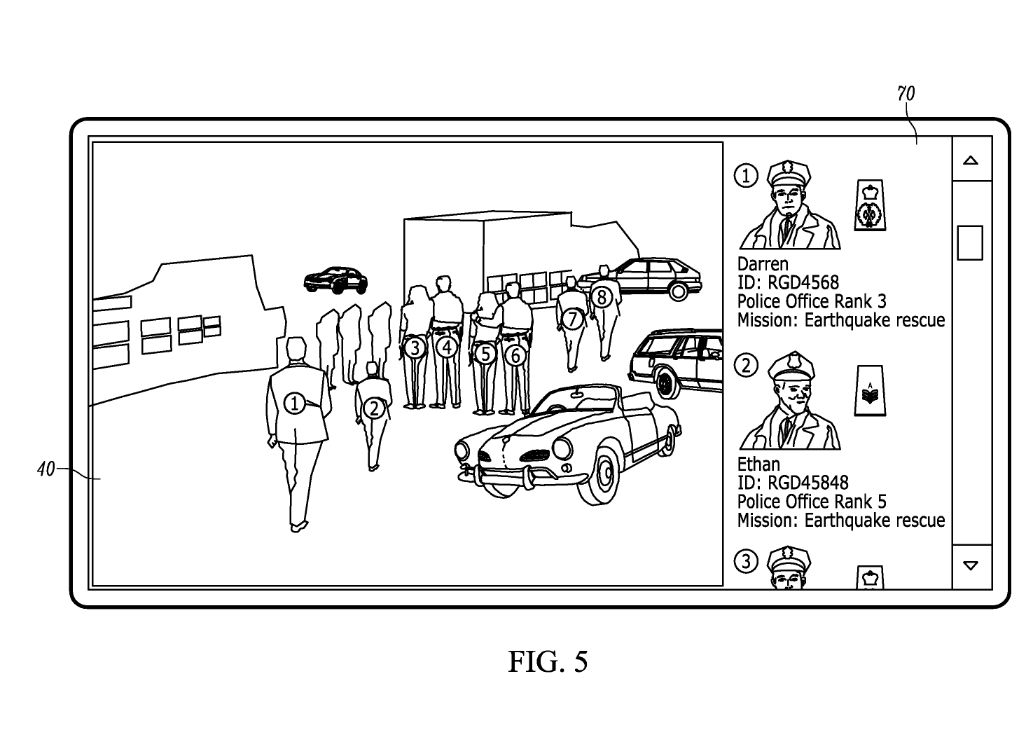

FIG. 5 illustrates an alternative embodiment of an overlay image displaying multiple personnel and multiple identifiers. As illustrated in FIG. 5, individual personnel are identified using reference numbers, and identifying information, corresponding to the numbers, is displayed in a scrollable area 70 of the display screen 40. The embodiments illustrated in FIGS. 3, 4, and 5 should not be considered limiting. Alternative embodiments of the display device 18 may display, in various ways, captured images of personnel overlaid with identifiers extracted from modulated infrared emissions from garments.

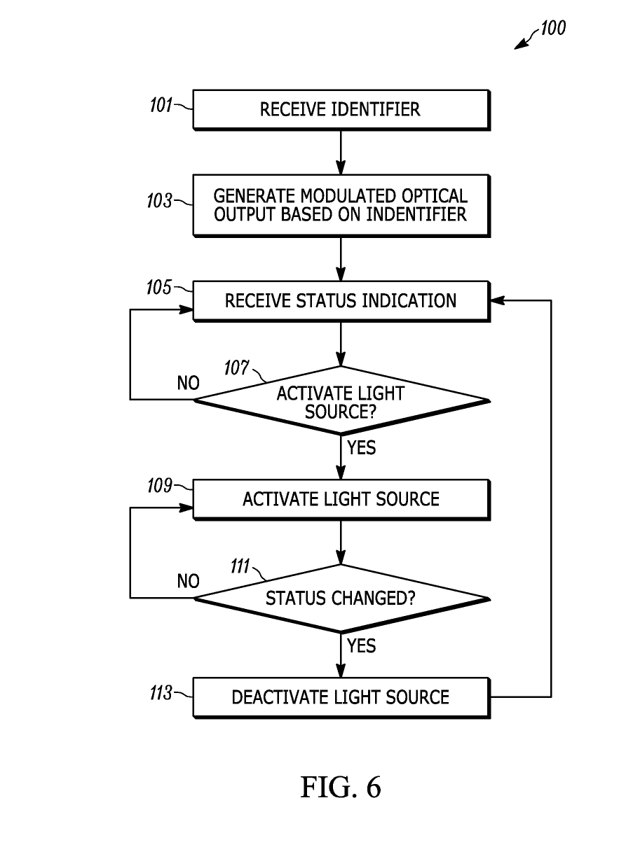

FIG. 6 illustrates an exemplary method 100 for operating the garment 12. At block 101, the communications interface 24 of the garment 12 receives an identifier from the portable communications device 14 via the communications link 30. As noted above, the identifier may be information about the wearer of the garment 12, or it may be a reference that can be used to retrieve such information from another source. The electronic controller 26 receives the identifier from the communications interface 24, and stores it in a memory. In some embodiments, the electronic controller 26 maintains the received identifier until it receives a different identifier from the portable communications device 14. In some embodiments, the portable communications device 14 periodically updates the identifier, regardless of whether it has changed. In alternative embodiments, the garment 12 receives the identifier from another source (for example, a configuration device) before it is assigned to a wearer or paired with the portable communications device 14.

At block 103, the electronic controller 26 generates a modulated optical output based on the identifier. The modulated optical output includes a sequence for activating and deactivating the light source 28 such that the light emitted by the light source 28 conveys the data to a device capable of reading the modulated light emissions. In one exemplary embodiment, the modulated optical output when used to control the light source 28, produces a data signal in the infrared spectrum. In another exemplary embodiment, the modulated optical output, when used to control the light source 28, produces a solid output of a single color in the visible spectrum.

At block 105, the communications interface 24 of the garment 12 receives a status indication from the portable communications device 14 via the communications link 30. The electronic controller 26 receives the identifier from the communications interface 24, and stores it in a memory. The status indication may be, for example, an indication that the portable communications device 14 is transmitting (that is, a transmit status), or it may be an indication that the portable communications device 14 is receiving communications (that is, a receive status). In alternative embodiments, the status indication may be a command received from the communications network controller 22, or another system, to activate the light source 28.

It will be appreciated that the portable communications device 14 sends status indications upon any change in status, and reception of status indications by the communications interface 24 may be continuous, and is not dependent upon prior or subsequent blocks in the method 100.

At block 107, the electronic controller 26 determines whether to activate the light source 28, using the modulated output generated at block 103, based on the status indication. In some embodiments, the electronic controller 26 activates the light source 28 when the portable communications device 14 is transmitting communications. In some embodiments, the electronic controller 26 activates the light source 28 when the portable communications device 14 is receiving communications. When the electronic controller 26 determines that it should activate the light source 28, at block 109, this may enable, for example, the display device 18, when processing images according to embodiments described herein, to identify individuals in the image who are using a device to transmit or to receive communications based on the activity of the device associated with each of those individuals. When the electronic controller 26 determines that it should not activate the light source 28, it will await reception of another status indication, at block 105.

At block 111, the electronic controller 26 determines whether the status indication has changed. When the status has not changed (that is, not new status indications have been received from the portable communications device 14), the electronic controller 26 will continue activating the light source 28 at block 109.

When the status has changed (for example, the portable communications device 14 sends a status indication that it is no longer transmitting), the electronic controller 26 deactivates the light source 28 at block 113 and resumes waiting for status indications at block 105.

In alternative embodiments, the light source 28 will activate, using the modulated output, continuously, regardless of the status indications received from the portable communications device 14. In another embodiments, the garment 12 or the portable communications device 14 may include a user interface device (for example, a button) to allow a wearer of the garment 12 to activate the light source manually.

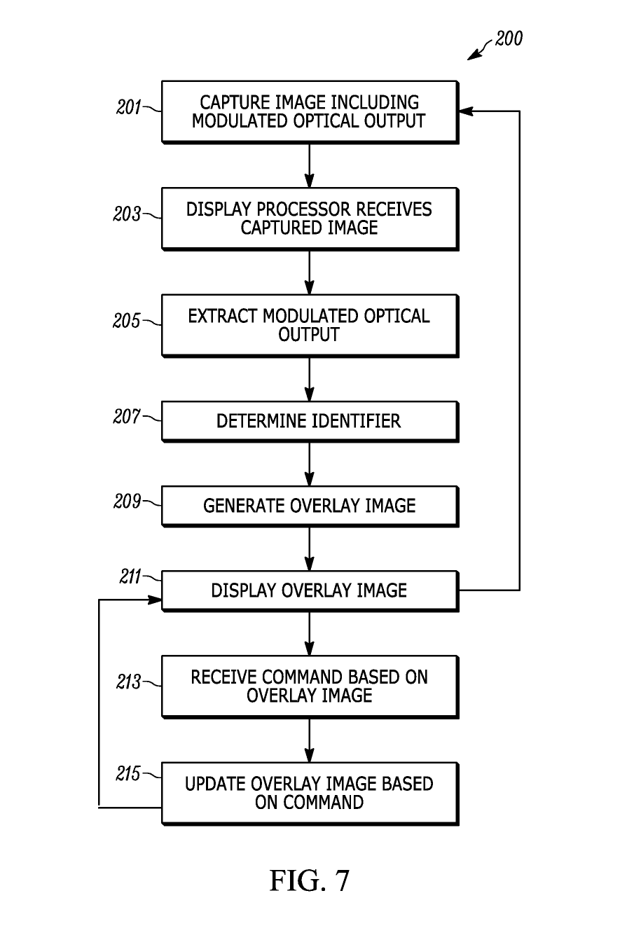

FIG. 7 illustrates an exemplary method 200 for operating the display device 18. At block 201, the camera 16 captures a first image 52 (shown in FIG. 2A) including an ordinary image of a police officer 50 and an infrared image 54 produced by the modulated output of the light source 28 of the garment 12. As noted above, an image may include one or more images, or a sequence of images (that is, a video sequence). Accordingly, the method 200 may be applied continuously to a video feed from the camera 16.

At block 203, the display processor 34 receives the first image 52 from the camera 16 via the input/output interface 38. At block 205, the display processor 34 extracts the modulated output from the first image 52. As illustrated in FIG. 2B, the display processor 34 generates a second image 56 that contains only the infrared image 54 from the first image 52. The display processor 34 detects the modulated output in the infrared image 54, and decodes the modulation to determine the identifier at block 207. As noted above, in some embodiments, the display processor 34 uses the identifier to retrieve information linked to the identifier (for example, a name or other information about a user)

At block 209, the display processor 34 generates an overlay image. An overlay image includes the visible spectrum portion of the captured image, overlaid with elements generated from the identifier determined at block 207. The third image 60, illustrated in FIG. 2C, is an example of an overlay image. In the illustrated example, the identifier contained the information “OFC. J. SMITH, POLICE,” from which the display processor 34 generates the user identifier 58. The display processor 34 overlays the user identifier 58 onto an image of the police officer 50 to generate an overlay image where the identifier (contained in the modulated light from the garment 12) appears over the garment 12. As illustrated in FIGS. 3, 4, and 5, the display processor 34 is capable of generating overlay images that include multiple garments and their corresponding identifiers, and the identifiers may contain text, graphics, or both.

As illustrated in FIGS. 3, 4, and 5, the display processor 34 displays the overlay image on the display screen 40, at block 211. In some embodiments, the display processor 34 displays the overlay image within a graphical user interface. As illustrated in FIG. 7, blocks 201 through 211 may be continuously repeated while the camera 16 is operating to capture images.

At block 213, the display processor 34 receives a command from the graphical user interface, based on the overlay image. For example, as illustrated in FIG. 4, a console operator 68 may select the identifier corresponding to the second police officer 64, issuing a command to initiate communications with the second police officer 64. In another example, selecting the identifier corresponding to the police officer 50 issues a command that allows the console operator 68 to enter supplemental information regarding the police officer 50. At block 215, the display processor 34 updates the overlay image based on the command received at block 213. For example, as illustrated in FIG. 4, the display processor 34 may overlay an information bubble 66 on the image of the police officer 50 indicating that he is injured. As illustrated in FIG. 7, the display processor 34 may operate continuously to receive commands and update the overlay images based on the commands, at blocks 211 through 215.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An automated personnel identification system, the system comprising:
a portable communications device storing an identifier uniquely identifying at least one of a group consisting of the portable communications device and a user of the portable communications device;
a garment including
a communications interface,
a light source,
an electronic controller electrically coupled to the communications interface and to the light source, the electronic controller configured to
receive the identifier, via the communications interface, from the portable communications device; and
cause the light source to generate a modulated optical output based on the identifier.

2. The personnel identification system of claim 1, wherein the electronic controller is further configured to
receive a status indication from the portable communications device via the communications interface; and
activate the light source based on the status indication.

3. The personnel identification system of claim 2, wherein the status indication is one selected from the group consisting of a receive status and a transmit status.

4. The personnel identification system of claim 1, wherein the electronic controller is further configured to activate the light source intermittently.

5. The personnel identification system of claim 1, wherein the electronic controller is further configured to activate the light source when the electronic controller receives an output of a user interface device.

6. The personnel identification system of claim 1, wherein the light source is an infrared light source and the modulated optical output is in the infrared spectrum.

7. The personnel identification system of claim 1, wherein the light source is an visible light source and the modulated optical output is in the visible spectrum.

8. The personnel identification system of claim 1, further comprising:
a camera configured to capture an image of the garment and at least a portion of the modulated optical output; and
a display processor electrically coupled to the camera and configured to
receive the image,
determine the identifier from the modulated optical output,
generate an overlay image based on the image and the identifier, and
receive, via a graphical user interface, a command based on the overlay image.

9. The personnel identification system of claim 8, wherein the command is at least one selected from the group consisting of a push-to-talk request, a talk group configuration request, a channel configuration request, and an information request.

10. A method for operating a personnel identification system that includes a portable communications device and a garment, the method comprising:
storing, by the portable communications device, an identifier associated with a user;
receiving, by an electronic controller of the garment, the identifier from the portable communications device; and
causing, by the electronic controller, a light source of the garment to generate a modulated optical output based on the identifier.

11. The method of claim 10, further comprising:
receiving, at communications interface of the garment, a status indication from the portable communications device; and
activating, by the electronic controller, the light source based on the status indication.

12. The method of claim 11, wherein receiving the status indication includes receiving one selected from the group consisting of a receive status and a transmit status.

13. The method of claim 10, further comprising:
activating, by the electronic controller, the light source intermittently.

14. The method of claim 10, further comprising:
activating the light source, by the electronic controller, when the electronic controller receives an output of a user interface device.

15. The method of claim 10, wherein causing the light source to generate a modulated output includes causing the light source to generate a modulated optical output in the infrared spectrum.

16. The method of claim 10, wherein causing the light source to generate a modulated output includes causing the light source to generate a modulated optical output in the visible spectrum.

17. The method of claim 10, further comprising:
capturing, by a camera configured, an image of the garment and at least a portion of the modulated optical output; and
receiving, by a display processor electrically coupled to the camera, the image,
determining, by the display processor, the identifier from the modulated optical output,
generating, by the display processor, an overlay image based on the image and the identifier, and
receiving, by a display processor via a graphical user interface, a command based on the overlay image.

18. The method of claim 17, wherein receiving the command based on the overlay image includes receiving at least one selected from the group consisting of a push-to-talk request, a talk group configuration request, a channel configuration request, and an information request.
